(19) United States
(12) Patent Application Publication
(10) Pub. No.: US 2004/0005387 A1
(43) Pub. Date: Jan. 8, 2004

(54) Method of preparing an improved tortilla sausage wrap

(75) Inventor: Danny V. Janecka, Waelder, TX (US)

Correspondence Address: JACKSON WALKER L.L.P., 112 E. Pecan Street, Suite 2100, San Antonio, TX, 78205, US

(73) Assignee: J & B SAUSAGE COMPANY

(21) Appl. No.: 10/407,014

(22) Filed: Apr. 4, 2003

Related U.S. Application Data
(60) Provisional application No. 60/370,374, filed on Apr. 5, 2002.

(51) Int. Cl. A23G 3/00

(52) U.S. Cl. 426/94

(57) ABSTRACT

A method of preparing a food product which includes a food items rolled in a tortilla. Prior to rolling the food item in the tortilla the tortilla is coated on one or both sides with a vegetable oil. This prevents hardening of the tortilla during subsequent heating.

This application claims priority from provisional patent application No. 60/370,374 filed Apr. 4, 2002.

### FIELD OF THE INVENTION

Tortilla wrapped food products, more particularly a tortilla wrapped food product having the tortilla coated with oil prior to rolling a food product thereinto.

### BACKGROUND OF THE INVENTION

Tortillas are best when soft, especially when the tortilla is used as a cover for a wrapped food item, such as a sausage link wrap, egg based or bean product. Sausage link wraps, for example, are popular fast food items as they can be carried in one hand and are rather tasty.

While the tortillas are often soft and pliable when the food item is initially wrapped therein, hardening often occurs with the addition of temperature to the wrap as during a subsequent warming of the food product. Hardening of the tortilla will often cause cracking and breakage of the tortilla, flaking and loss of the integrity of the wrap. The entire wrap may turn out to be a mess.

Wraps may be often prepared using a precooked sausage link rolled into a cooked tortilla, the wrap may then be boxed and frozen for subsequent usage, such as by thawing and reheating or warming and serving.

Applicant has found that by coating a tortilla, preferably on one side (typically the outer side) of the tortilla, typically prior to rolling the food item therein, the subsequent heating for a controlled time at a controlled temperature will forestall or prevent hardening. Further, if a roller grill is used (as is preferable), a specific orientation of the lip of the wrap to the direction of the roll will help maintain the integrity of the wrap during the heating process.

### BRIEF DESCRIPTION OF THE DRAWINGS

FIGS. 1A and 1B are front elevational and side cutaway elevational views, respectively, of the food wrap of applicants present invention.

FIGS. 2A and 2B illustrate a side elevational cutaway and perspective views, respectively, to methods of applying oil to a surface of the tortilla.

FIG. 3 illustrates the manner in which a tortilla is rolled around a food item.

FIG. 4 illustrates a perspective view of food items on a roller grill being heated.

FIG. 5 illustrates the food wrap being stacked in a box.

FIG. 6 illustrates the use of a roller grill for warming the wrap in the manner in which the placement of the wrap orients the lip to face away from the direction of roll of the wrap.

FIG. 7 illustrates a cross sectional view of the tortilla wrap showing the tortilla in the manner in which an oil coating 32 is provided on a first surface 10B and is at least partially absorbed into the tortilla so as to create a vapor barrier for hot, vaporous gases (hours) driven from the sausage link or other food item by heating thereof.

FIG. 8 illustrates a cross sectional view of the tortilla wrap that has been heated at too high a temperature or for too long and vaporous (arrows) have substance escape, taking part of the natural dampness of the flexible tortilla and allowing some hardening of the tortilla.

### DETAILED DESCRIPTION OF THE PREFERRED EMBODIMENT

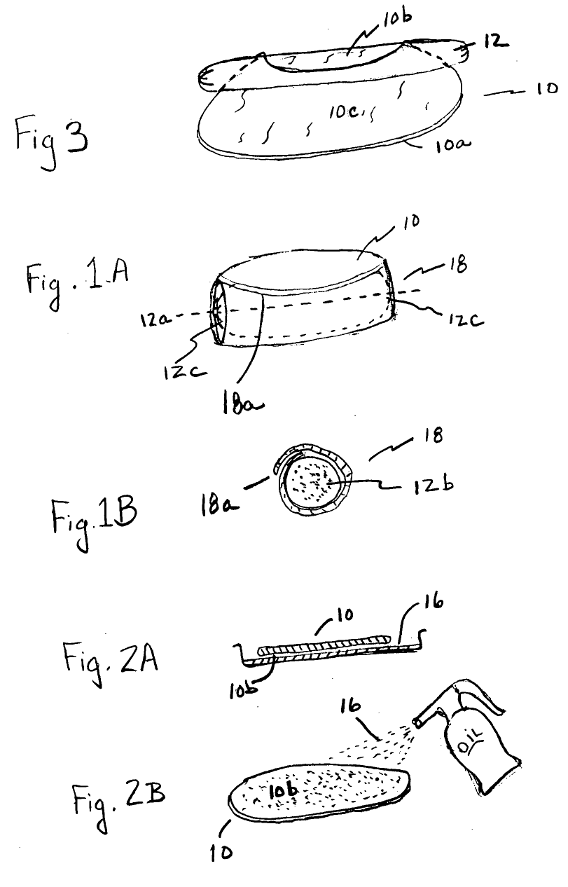

The subject matter of Applicant's invention is a method of preparing a food product described herein as a “wrap” (18) (see, for example, FIGS. 1A and 1B). It is known that sausage links have been provided cooked and while still warm, wrapped into a tortilla for vending to a customer. Such wraps are popular at ball games, amusement parks, carnivals and other assemblies of people. However, the application of heat, either during the heating process of the wrap itself or by application of a hot sausage to a cooled tortilla will usually result in the drying out of the tortilla before the food product is consumed. The loss of integrity, cracking and flaking of the product can be frustrating to the consumer who may often end with a mass of cracked tortilla shell oozing sausage therefrom.

The subject of Applicant's invention includes a method of preparing a novel food wrap, typically a sausage in a tortilla, to avoid the hardening.

Applicant's method begins by providing a typical circular tortilla 10, having a diameter of about 4 to 8 inches and providing a cylindrical sausage link, egg or bean filling, typically having a longitudinal axis approximately equal to the diameter of the tortilla. FIGS. 1A and 1B illustrate a circular tortilla (10). The circular tortilla has a perimeter (10a) and a first surface (10b) and a second surface (10c). Applicant also provides a link (such as a sausage link) or other food filler 12 which may have a longitudinal axis (12a). The sausage link or food filler typically includes a body (12b) and a pair of removed ends (12c) at opposed ends of the body.

Applicant also provides a means of heating, typically a roller grill (14) (see FIG. 4), the roller grill having a temperature selection means (14a), such as an adjustable thermostat, for setting the temperature of a multiplicity of rollers (14b) spaced apart longitudinally upon which a food wrap may be oriented and heated, for a preselected time, as set forth in greater detail below. Applicant also provides a source of vegetable oil (see FIGS. 2A and 2B) such as Wesson, LuAnna or Sysco Brands. FIG. 2B illustrates a source of vegetable oil (16), for example, here contained in a spray bottle, for application either to a surface of a pan (see FIG. 2A) upon which a tortilla will be subsequently placed, or by spraying directly onto a first surface of the tortilla (FIG. 2B) or by any other suitable manner. Applicant anticipates either the manual application of vegetable oil to a first surface of the tortilla or an automated means thereof, such as an assembly line with a spray apparatus atomizing vegetable oil and placed adjacent to the passage of tortillas.

FIG. 2A illustrates the placement of a tortilla (10) with a first surface (10b) placed on a pan which has been coated With a thin layer of vegetable oil (16). Thus, FIG. 2A illustrates one manner of an applying step, namely the application of a layer of oil to a first surface of the tortilla, as, for example, by placing the tortilla face down on a flat surface, such as a pan having oil layered thereon. FIG. 3 illustrates the manner of the step of placing (here done manually), wherein a food item such as a sausage link (12) is placed adjacent the perimeter of the tortilla and rolled, with the second (typically uncoated) surface of the tortilla against the sausage. Rolling is completed with most of the body and, perhaps even the removed ends of the sausage within the perimeter of the wrap as defined by the tortilla, and holding the cylindrical shape seen in FIG. 1A. It is to be noted that it is preferable to roll the tortilla with a dry or uncoated second surface (10c) adjacent the tortilla and to size the link with respect to the tortilla such that the tortilla, when rolled completely around the sausage, will cover substantially all of the body of the sausage link or other food item. Note that the wrap (18) created, thus depicted, for example with reference to FIGS. 1A and 1B, will have a lip (18a) defined by a portion of the perimeter of the tortilla.

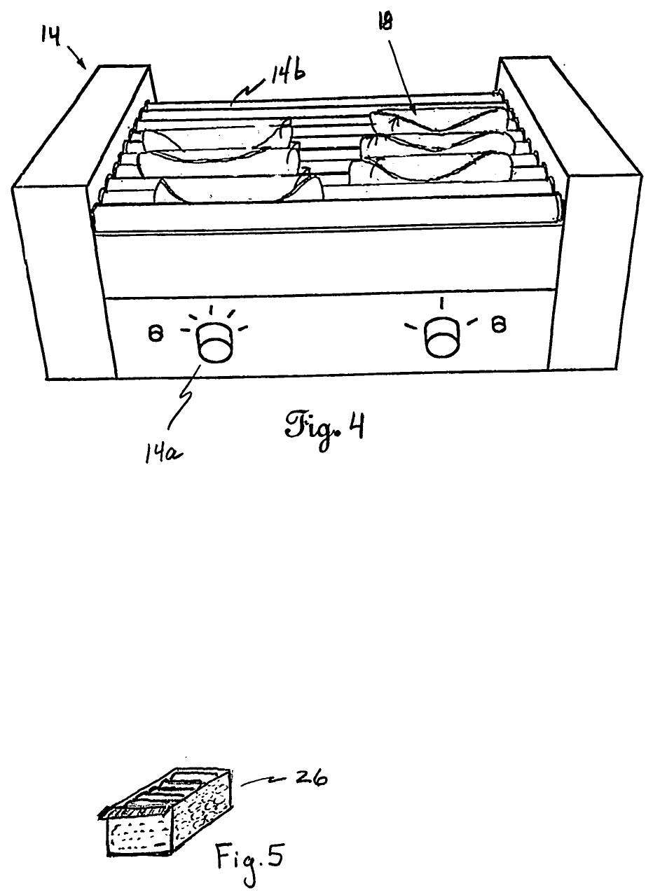

FIG. 5 illustrates a manner of stacking and boxing (26) a multiplicity of wraps (18) in a rectangular, plastic lined, cardboard box for subsequent enclosure, freezing and shipment to a remote area, for example a convenience store. Boxing (26) is preferred for shipping a multiplicity of wraps to a remote location or even just for freezing them.

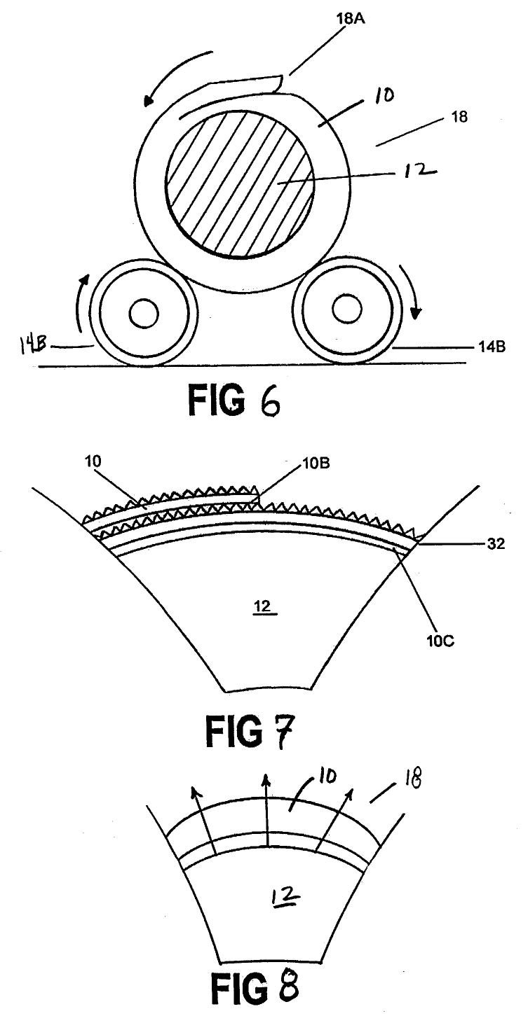

The steps of freezing and thawing, being old in the art, is not illustrated. A roller grill (14) having a multiplicity of rollers (14b) thereon is provided for selecting a temperature sufficient to warm the wrap. FIG. 6 illustrates a selecting step and a step of placing the wrap on the grill such that it rotates away from the lip (18a). The placing step is achieved by orienting the wrap such that lip (18a) follows the direction of rotation of the wrap (see arrow in FIG. 6).

The temperature selecting step is next, the temperature should not be too great as to drive the warm vapors generated from the sausage link during the heating process (see FIG. 8) through the vapor barrier that Applicant believes is created by the oil coating on the tortilla (see FIG. 7). FIG. 7 illustrates a temperature condition wherein an oil layer (32) on an outer coated surface of the tortilla (10) is sufficient to act as a vapor barrier preventing the escape of too much vapor from link (12), the vapor from link (12) maintaining a softness to the tortilla and the oil on the outer surface creating both a barrier and a softening agent to prevent the hardening of the tortilla during the heating process. Typical roller grill heating temperatures that are sufficient to warm the links over a 5 to 30-minute period, for example, are in the range of 140°-160°.

FIG. 8 illustrates the condition in which moisture is depleted from the tortilla having been driven by excessive temperatures of the roller grill and, may subsequently cause some cracking of the tortilla as well as overheating of the entire food product.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. For example, one may coat the inner surface of the tortilla or both surfaces of the tortilla. It is, therefore, contemplated that the appended claims will cover such modifications that fall within the scope of the invention.

I claim:

1. A method of preparing a food product, the method comprising as steps:
providing a circular tortilla having a perimeter and a first surface and a second surface;
providing a food item, the food item having a longitudinal axis, a body and removed ends:
providing a roller grill, the roller grill including a temperature selection means thereon;
providing a source of oil;
applying a layer of the oil to one of the first surface or the second surface of the tortilla;
placing the food item adjacent the other of the first surface or the second surface of the tortilla;
rolling the food item in the tortilla leaving a wrap, the wrap comprising the tortilla substantially enclosing the body of the food item and leaving a lip defined by the perimeter of the tortilla;
boxing the wrap with other wraps;
freezing the boxed wraps;
thawing the wrap;
selecting a roller grill temperature sufficient to maintain moisture and pliability in the tortilla during the rotating process;
placing a wrap on the roller grill;
rotating the wrap for a period of time sufficient to warm the body of the sausage link; and
removing the wrap from the roller grill.

2. The method of claim 1 wherein the food item is one of the following:
sausage link, egg product or bean product.

3. The method of claim 1 wherein the placing step is done such that the lip is concave to the rollers.

4. The method of claim 1 wherein the oil is vegetable oil.

5. The method of claim 1 wherein the applying step includes spraying oil.

6. The method of claim 1 wherein the applying step includes the step of immersing the first or the second surface in oil.

7. The method of claim 1 wherein the oil is applied to the first surface and the food item is placed against the second surface.

8. A food product comprising a food filler; and
a tortilla shell having at least one surface coated with oil adapted to substantially enclose the food filler.

9. The food product of claim 8 wherein the tortilla shell is coated on only one surface.

10. The food product of claim 9 wherein the tortilla shell's uncoated surface is adjacent the food filler.

11. The food product of claim 8 wherein the food filler is one of a sausage link, an egg product or a bean product.
